(19) United States
(12) Patent Application Publication
(10) Pub. No.: US 2011/0122373 A1
(43) Pub. Date: May 26, 2011

(54) LIGHT EMITTING APPARATUS AND PROJECTOR

(75) Inventor: Hiroyasu KASEYA, Suwa (JP)

(73) Assignee: SEIKO EPSON CORPORATION, Tokyo (JP)

(21) Appl. No.: 12/902,192

(22) Filed: Oct. 12, 2010

(30) Foreign Application Priority Data
Nov. 20, 2009 (JP) 2009-264774

(51) Int. Cl. G03B 21/28; F21V 7/00

(52) U.S. Cl. 353/37; 362/297

(57) ABSTRACT

A light emitting apparatus includes: a light emitting device, the light emitting device emitting first and second emitted light; a first optical element; and a second optical element, wherein the first optical element includes a first lens surface on which the first emitted light is incident, a first reflection surface that reflects the light having passed through the first lens surface, and a second lens surface that refracts the light reflected off the first reflection surface, the second optical element includes a third lens surface on which the second emitted light is incident, a second reflection surface that reflects the light having passed through the third lens surface, and a fourth lens surface that refracts the light reflected off the second reflection surface, and the light having exited through the second lens surface and the light having exited through the fourth lens surface travel in the same direction.

### BACKGROUND

1. Technical Field

The present invention relates to a light emitting apparatus and a projector.

2. Related Art

When a light emitting device formed of a chip and emitting light through both end surfaces of the chip is used, a mirror is used in some cases, for example, to direct the light beams having exited through both end surfaces in the same direction. As an example in which a mirror is used to change the traveling direction of light, JP-A-10-153720, for example, discloses a configuration in which a light emitting device emits light parallel to the upper surface of a semiconductor substrate and the light is incident on a lens after redirected at an inclined surface that is one of the surfaces of a prism and inclined to the upper surface of the semiconductor substrate by 45 degrees. That is, in JP-A-10-153720, the inclined surface of the prism functions as a mirror for changing the traveling direction of light.

The light emitted from a semiconductor laser or any other light emitting device, however, typically has a large angle of radiation. In the configuration in which the emitted light is reflected off the mirror and then incident on the lens as described, for example, in JP-A-10-153720, the light emitted from the light emitting device travels along a long optical path before the light is incident on the lens. In this case, a lens having a large aperture diameter is required, and the size of an apparatus is increased accordingly.

### SUMMARY

An advantage of some aspects of the invention is to provide a small light emitting apparatus. Another advantage of some aspects of the invention is to provide a projector including the light emitting apparatus.

A light emitting apparatus according to a first aspect of the invention includes abase, a light emitting device supported by the base, the light emitting device emitting first emitted light and second emitted light traveling in opposite directions, a first optical element on which the first emitted light is incident, and a second optical element on which the second emitted light is incident. The first optical element includes a first lens surface on which the first emitted light is incident and which refracts the first emitted light, a first reflection surface that reflects the light having passed through the first lens surface, and a second lens surface that refracts the light reflected off the first reflection surface. The second optical element includes a third lens surface on which the second emitted light is incident and which refracts the second emitted light, a second reflection surface that reflects the light having passed through the third lens surface, and a fourth lens surface that refracts the light reflected off the second reflection surface. The light having exited through the second lens surface of the first optical element and the light having exited through the fourth lens surface of the second optical element travel in the same direction.

According to the light emitting apparatus described above, the first optical element can use the first lens surface to convert the first emitted light into collimated light before the first emitted light is reflected off the first reflection surface. Similarly, the second optical element can use the third lens surface to convert the second emitted light into collimated light before the second emitted light is reflected off the second reflection surface. As a result, since the light beams emitted from the light emitting device travel shorter distances along their optical paths before they are incident on the first and third lens surfaces, the light beams incident on the first and third lens surfaces can be small in diameter. The aperture diameters of the first and third lens surfaces can therefore be reduced. As a result, the optical elements and hence the light emitting apparatus can be small in size.

In the light emitting apparatus according to the first aspect of the invention, the base may have a first surface that supports the first reflection surface of the first optical element and a second surface that supports the second reflection surface of the second optical element.

The light emitting apparatus described above allows the optical axes of the first and second optical elements to be readily adjusted with respect to the light emitting device.

In the light emitting apparatus according to the first aspect of the invention, the base may have a third surface that supports the light emitting device. The light emitting device may be disposed in such a way that the traveling direction of the first emitted light and the traveling direction of the second emitted light are parallel to the third surface. The first and second reflection surfaces may be inclined to the third surface by 45 degrees.

The light emitting apparatus described above allows the traveling direction of the first emitted light and the traveling direction of the light reflected off the first reflection surface to be perpendicular to each other and the traveling direction of the second emitted light and the traveling direction of the light reflected off the second reflection surface to be perpendicular to each other.

In the light emitting apparatus described above, the light emitting device may be a super luminescent diode.

The light emitting apparatus described above can prevent laser oscillation because formation of an end surface reflection resonator is suppressed, whereby the amount of speckle noise can be reduced.

In the light emitting apparatus according to the first aspect of the invention, the light emitting device may have a plurality of first exiting surfaces through each of which the first emitted light exits and a plurality of second exiting surfaces through each of which the second emitted light exits.

The light emitting apparatus described above can increase the output therefrom.

A projector according to a second aspect of the invention includes the light emitting apparatus according to the first aspect of the invention, a light modulating apparatus that modulates the light having exited from the light emitting apparatus in accordance with image information, and a projection apparatus that projects an image formed by the light modulating apparatus.

According to the projector described above, the light emitting apparatus according to the first aspect of the invention can be used as a light source. The size of the projector can therefore be reduced.

### BRIEF DESCRIPTION OF THE DRAWINGS

The invention will now be described with reference to the accompanying drawings, wherein like numbers reference like elements.

FIG. 1 is a plan view diagrammatically showing a light emitting apparatus according to an embodiment.

FIG. 2 is a cross-sectional view diagrammatically showing the light emitting apparatus according to the embodiment.

FIG. 3 is another cross-sectional view diagrammatically showing the light emitting apparatus according to the embodiment.

FIG. 4 is a cross-sectional view diagrammatically showing a step of manufacturing the light emitting apparatus according to the embodiment.

FIG. 5 is a cross-sectional view diagrammatically showing another step of manufacturing the light emitting apparatus according to the embodiment.

FIG. 6 is a cross-sectional view diagrammatically showing another step of manufacturing the light emitting apparatus according to the embodiment.

FIG. 7 is a cross-sectional view diagrammatically showing another step of manufacturing the light emitting apparatus according to the embodiment.

FIG. 8 is a cross-sectional view diagrammatically showing a light emitting apparatus according to a first variation of the embodiment.

FIG. 9 is a cross-sectional view diagrammatically showing a light emitting apparatus according to a second variation of the embodiment.

FIG. 10 is a plan view diagrammatically showing a light emitting apparatus according to a third variation of the embodiment.

FIG. 11 diagrammatically shows a projector according to the embodiment.

### DESCRIPTION OF EXEMPLARY EMBODIMENTS

A preferred embodiment of the invention will be described below with reference to the drawings.

### 1. Light Emitting Apparatus

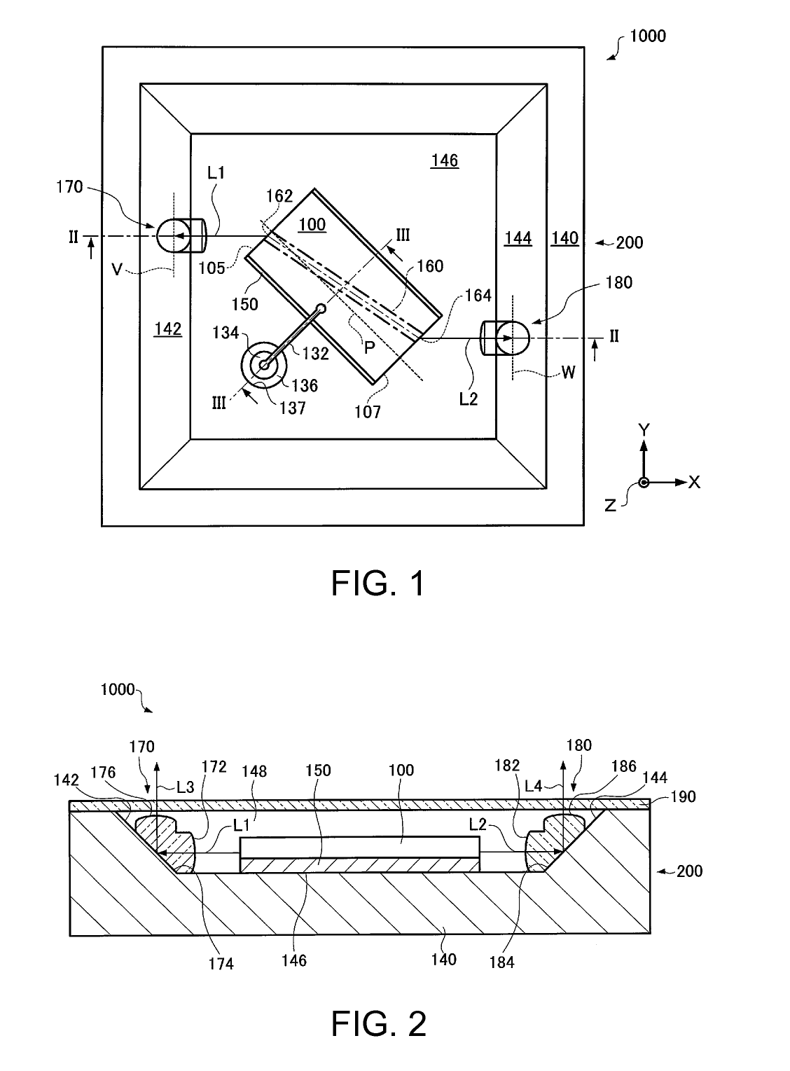

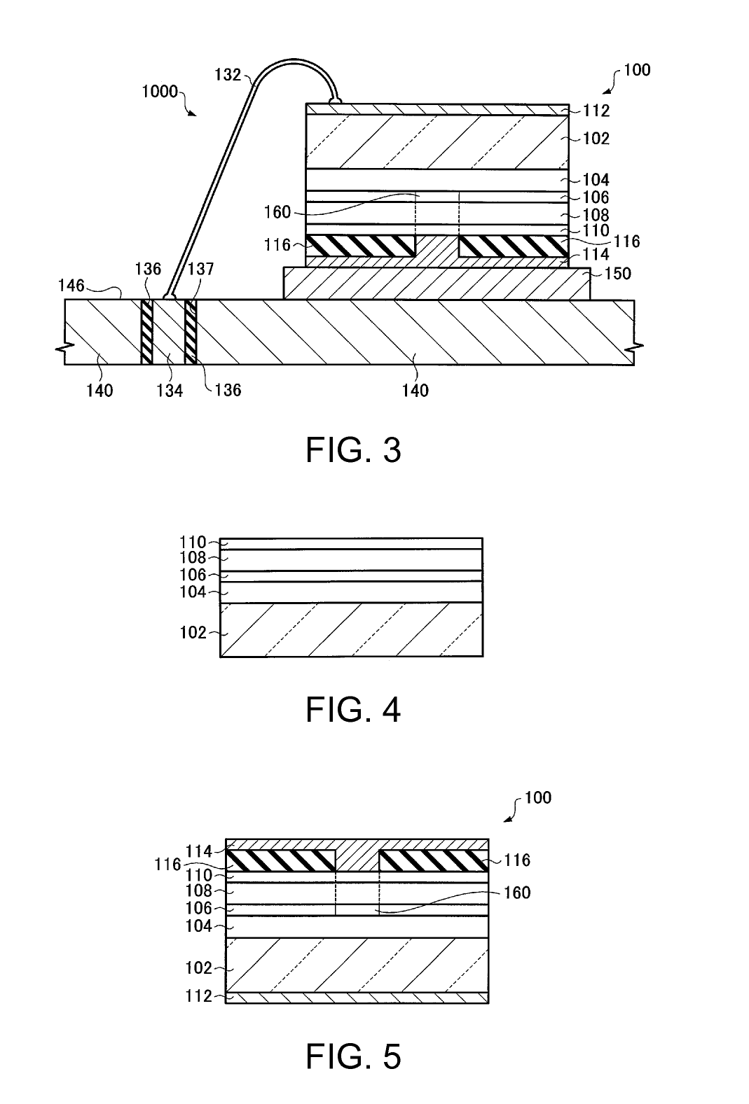

A light emitting apparatus 1000 according to the present embodiment will first be described with reference to the drawings. FIG. 1 is a plan view diagrammatically showing the light emitting apparatus 1000. FIG. 2 is a cross-sectional view diagrammatically showing the light emitting apparatus 1000 taken along the line II-II in FIG. 1. FIG. 3 is a cross-sectional view diagrammatically showing the light emitting apparatus 1000 taken along the line III-III in FIG. 1. In FIGS. 1 and 3, a lid 190 is omitted for ease of illustration. In FIG. 2, a light emitting device 100 is simplified for ease of illustration.

The light emitting apparatus 1000 includes a package 200 formed of a base 140 and a lid 190, a light emitting device 100, a first optical element 170, and a second optical element 180, as shown in FIGS. 1 to 3. The light emitting apparatus 1000 can further include a sub-mount 150, an insulating member 136, a terminal 134, and a connecting member 132. In the present embodiment, a description will be made of a case where the light emitting device 100 is a super luminescent diode (hereinafter also referred to as an “SLD”) made of an InGaAlP-based material (emitting red light). An SLD can prevent laser oscillation because formation of an end surface reflection resonator is suppressed, unlike a typical semiconductor laser. The amount of speckle noise can be reduced in an SLD.

The light emitting device 100 is mounted on the base 140 of the package 200 via the sub-mount 150. In the illustrated example, the number of light emitting device 100 mounted on the based 140 is one, but the number is not limited to a specific value. For example, a plurality of light emitting devices 100 may be mounted. In this case, the output from the entire light emitting apparatus can be increased. The light emitting device 100 is supported by a third surface 146 of the base 140. The light emitting device 100 includes a cladding layer (hereinafter referred to as a “first cladding layer”) 108, an active layer 106 formed thereon, and a cladding layer formed thereon (hereinafter referred to as a “second cladding layer”) 104, as shown in FIG. 3. The light emitting device 100 can further include a substrate 102, a contact layer 110, an electrode (hereinafter referred to as a “first electrode”) 114, an electrode (hereinafter referred to as a “second electrode”) 112, and an insulator 116.

The substrate 102 can be, for example, a GaAs substrate of a first conductivity type (n-type, for example).

The second cladding layer 104 is formed under the substrate 102. The second cladding layer 104 can be, for example, an n-type AlGaInP layer. Although not shown, a buffer layer may be formed between the substrate 102 and the second cladding layer 104. The buffer layer can, for example, be an n-type GaAs layer or InGaP layer.

The active layer 106 is formed under the second cladding layer 104. In the light emitting device 100, the active layer 106 is disposed, for example, on the side close to the base 140. That is, the active layer 106 is disposed, for example, below the intermediate level in the thickness direction (on the opposite side of the intermediate level to the substrate 102) in the light emitting device 100. The active layer 106 is sandwiched between the second cladding layer 104 and the first cladding layer 108. The active layer 106 has, for example, a multiple quantum well (MQW) structure in which three quantum well structures each of which is formed of an InGaP well layer and an InGaAlP barrier layer are stacked.

The active layer 106 has, for example, a box-like shape (including a cubic shape). The active layer 106 has a first side surface 105 and a second side surface 107, as shown in FIG. 1. The first side surface 105 and the second side surface 107 face away from each other and, for example, are parallel to each other. The active layer 106 sandwiched between the first cladding layer 108 and the second cladding layer 104 forms, for example, a laminate structure. Among the surfaces of the active layer 106, the first side surface 105 and the second side surface 107 are not in contact with the first cladding layer 108 or the second cladding layer 104, and it can also be said that the first side surface 105 and the second side surface 107 are exposed surfaces of the laminate structure. The laminate structure may further include the substrate 102 and the contact layer 110.

Part of the active layer 106 forms a gain region 160, which forms a current path in the active layer 106. The gain region 160 can produce light, which can be amplified in the gain region 160. The shape of the gain region 160 in a plan view is, for example, a parallelogram. The gain region 160 is provided from the first side surface 105 to the second side surface 107 and inclined to a normal P to the first side surface 105 when viewed from the above in the laminated direction of the active layer 106 (when viewed in the thickness direction of the active layer 106), as shown in FIG. 1. The shape of the gain region 160 suppresses or prevents laser oscillation of the light produced therein. It is noted that when the gain region 160 is oriented in a certain direction, the certain direction in a plan view coincides with the direction passing through the center of a first end surface 162, which is the end surface of the gain region 160 on the side where the first side surface 105 is present, and the center of a second end surface 164, which is the end surface of the gain region 160 on the side where the second side surface 107 is present.

Although not illustrated, the gain region 160 may alternatively be provided in a linear portion from the first end surface 162 on the side where the first side surface 105 is present to the second end surface 164 on the side where the second side surface 107 is present and oriented in the direction parallel to the normal P to the first side surface 105. In this case, a resonator is formed and laser light can be produced. That is, the light emitting device 100 may be, for example, a semiconductor laser.

The first cladding layer 108 is formed under the active layer 106, as shown in FIG. 3. The first cladding layer 108 can be, for example, an AlGaInP layer of a second conductivity type (p-type, for example).

For example, the p-type first cladding layer 108, the active layer 106, to which no impurity is doped, and the n-type second cladding layer 104 form a pin diode. Each of the first cladding layer 108 and the second cladding layer 104 is a layer having a wider band gap and a smaller refractive index than those of the active layer 106. The active layer 106 has a function of light amplification. The first cladding layer 108 and the second cladding layer 104, which sandwich the active layer 106, have a function of trapping injected carriers (electrons and holes) and light.

The contact layer 110 is formed under the first cladding layer 108. The contact layer 110 can be a layer that allows ohmic contact with the first electrode 114. The contact layer 110 can be made, for example, of a semiconductor material of the second conductivity type. The contact layer 110 can be, for example, a p-type GaAs layer.

The insulator 116 is formed under the contact layer 110 except the portion below the gain region 160. That is, the insulator 116 has an opening located below the gain region 160, and the opening exposes the corresponding surface of the contact layer 110. The insulator 116 can be, for example, a SiN layer, a SiO₂ layer, or a polyimide layer.

The first electrode 114 is formed under the exposed portion of the contact layer 110 and the insulator 116. The first electrode 114 is electrically connected to the first cladding layer 108 via the contact layer 110. The first electrode 114 is one of the electrodes for driving the light emitting device 100. The first electrode 114 can be, for example, a Cr layer, an AuZn layer, and an Au layer stacked in this order on the contact layer 110. The surface where the first electrode 114 is in contact with the contact layer 110 has the same shape in a plan view as the shape of the gain region 160. In the illustrated example, the plan shape of the surface where the first electrode 114 is in contact with the contact layer 110 can determine the current path between the electrodes 112 and 114 and hence the plan shape of the gain region 160.

The second electrode 112 is formed over the entire surface of the substrate 102. The second electrode 112 can be in contact with a layer that allows ohmic contact with the second electrode 112 (the substrate 102 in the illustrated example). The second electrode 112 is electrically connected to the second cladding layer 104 via the substrate 102. The second electrode 112 is the other one of the electrodes for driving the light emitting device 100. The second electrode 112 can be, for example, a Cr layer, an AuGe layer, an Ni layer, and an Au layer stacked in this order on the substrate 102. A second contact layer (not shown) can be provided between the second cladding layer 104 and the substrate 102. In this case, the portion of the second contact layer that faces the substrate 102 is, for example, dry-etched and exposed, and the second electrode 112 is provided on the second contact layer. A one-sided electrode structure can thus be provided. The second contact layer can be, for example, an n-type GaAs layer.

In the light emitting device 100, when a forward bias voltage at which the pin diode is activated is applied between the first electrode 114 and the second electrode 112, electrons are recombined with holes in the gain region 160 of the active layer 106. The recombination leads to light emission. The produced light triggers stimulated emission in a chain reaction, and the light travels through the gain region 160, and the intensity of the light is amplified therein. Part of the amplified light exits through the first end surface (first exiting surface) 162, and the light is referred to as first emitted light L1. Another part of the amplified light exits through the second end surface (second exiting surface) 164, and the light is referred to as second emitted light L2. The first emitted light L1 and the second emitted light L2 can, for example, be refracted and exit in a direction inclined by an angle greater than the inclination angle of the gain region 160 with respect to the normal P to the first side surface 105. The first emitted light L1 and the second emitted light L2 can travel, for example, in the direction parallel to the upper surface of the active layer 106 (horizontal direction). The first emitted light L1 and the second emitted light L2 travel in opposite directions.

The package 200 can include the base 140 and the lid 190, as shown in FIG. 2.

The base 140 can indirectly support the light emitting device 100 via the sub-mount 150. The base 140 can be, for example, a plate-shaped (box-shaped) member with a recess 148. The base 140 has a first surface 142, a second surface 144, and a third surface 146. The first surface 142 can support a first reflection surface 174 of the first optical element 170. In the illustrated example, the first surface 142 is in contact with the first reflection surface 174. The second surface 144 can support a second reflection surface 184 of the second optical element 180. In the illustrated example, the second surface 144 is in contact with the second reflection surface 184. The first surface 142 and the second surface 144 can, for example, be inclined to the third surface 146 by 45 degrees. The third surface 146 can be a surface that supports the light emitting device 100. In the illustrated example, the third surface 146 supports the light emitting device 100 via the sub-mount 150. The light emitting device 100 is disposed in such a way that the traveling direction of the emitted light L1 and L2 is parallel to the third surface 146. The number of side surfaces of the recesses 148 is, for example, four. The light emitting device 100 is surrounded, for example, by the four side surfaces of the recess 148. In the illustrated example, the first surface 142 and the second surface 144 of the base 140 form side surfaces of the recess 148, and the third surface 146 of the base 140 forms the bottom surface of the recess 148.

The base 140 has a through hole 137 having a cylindrical shape or any other suitable shape, as shown in FIGS. 1 and 3. The terminal 134, which has a cylindrical shape and the side surface of which is covered with the insulating member 136, is inserted in the through hole 137. The insulating member 136 is made, for example, of a resin or a ceramic (AlN, for example). The terminal 134 is made, for example, of copper (Cu).

The terminal 134 is connected to the second electrode 112 of the light emitting device 100 via the connecting member 132, such as a wire bonding line. The connecting member 132 is disposed not to interfere with the optical paths of the emitted light L1 and L2. The first electrode 114 of the light emitting device 100 is connected to the sub-mount 150, for example, via plated bumps (not shown). The sub-mount 150 is connected to the base 140. A voltage can be applied between the first electrode 114 and the second electrode 112 by providing the terminal 134 and the base 140 with different potentials.

The sub-mount 150 is supported by the third surface 146 of the base 140. The sub-mount 150 can be, for example, a plate-shaped member. The sub-mount 150 can directly support the light emitting device 100.

The thermal conductivity of the base 140 is higher than that of the sub-mount 150, and the thermal conductivity of the sub-mount 150 is higher than that of the light emitting device 100. The thermal conductivity of each of the based 140 and the sub-mount 150 is, for example, at least 140 W/mK. The coefficient of thermal expansion of the sub-mount 150 is desirably close to that of the light emitting device 100. For example, although not shown, if the light emitting device 100 is mounted directly on the base 140 without the sub-mount 150 interposed therebetween, the difference in the coefficient of thermal expansion between the base 140 and the light emitting device 100 may induce warpage due to overheating when the light emitting device 100 is mounted or heat generated when the light emitting device 100 is driven. In this case, the light emitting device 100 is stressed and the reliability thereof may decrease in some cases. In view of the problem described above, the reliability of the light emitting device 100 can be improved in the present embodiment by using the sub-mount 150 to reduce the magnitude of the stress induced by the difference in the coefficient of thermal expansion between the base 140 and the light emitting device 100. The base 140 can be made, for example, of any of Cu, Al, Mo, W, Si, C, Be, Au, a compound thereof (AlN and BeO, for example), and an alloy thereof (CuMo, for example). The base 140 may alternatively be made of a combination of those described above, such as a multilayer structure formed of a copper (Cu) layer and a molybdenum (Mo) layer. The sub-mount 150 can be made, for example, of any of AlN, CuW, SiC, BeO, CuMo, and a multilayer structure formed of copper (Cu) and a molybdenum (Mo) layer (CMC).

The first optical element 170 is supported by the base 140. More specifically, the first optical element 170 is supported by the first surface 142 and the third surface 146 of the base 140. The first optical element 170 can convert the first emitted light L1 emitted from the light emitting device 100 into collimated light and change the traveling direction of the first emitted light L1. The first optical element 170 has a first lens surface 172, the first reflection surface 174, and a second lens surface 176. The first lens surface 172 is a surface on which the first emitted light L1 is incident. The first lens surface 172 can convert the first emitted light L1 into collimated light. The first emitted light L1 can be refracted at the first lens surface 172 and converted into collimated light. The first lens surface 172 can be, for example, a convex surface. The first lens surface 172 may alternatively be an aspheric surface, which can reduce the amount of aberration. The first reflection surface 174 can reflect the light having passed through the first lens surface 172 upward above the light emitting device 100, as shown in FIG. 2. The first emitted light L1 is reflected off the first reflection surface 174 and can travel, for example, vertically upward (direction Z in FIG. 1) with respect to the third surface 146 of the base 140. The reflected light is referred to as first reflected light L3. The first reflection surface 174 is inclined, for example, to the third surface 146 by 45 degrees. As a result, the traveling direction of the first reflected light L3 can be perpendicular to the traveling direction of the first emitted light L1. The reflectance at which the first reflection surface 174 reflects the first emitted light L1 is preferably higher than 50% but lower than or equal to 100%. The second lens surface 176 can convert the first reflected light L3 into collimated light. The first reflected light L3 can be refracted at the second lens surface 176 and converted into collimated light. The second lens surface 176 can be the surface of the first optical element 170 through which light exits. The second lens surface 176 can be, for example, a convex surface. The second lens surface 176 may alternatively be an aspheric surface, which can reduce the amount of aberration. The first optical element 170 can use the first lens surface 172 and the second lens surface 176 to convert the first emitted light L1 into collimated light. Therefore, the parallelism of the light having exited through the second lens surface 176 can be higher (the degree of divergence of the light is smaller) than that obtained in a case where only one lens surface converts the first emitted light L1 into collimated light. Further, according to the configuration described above, deviation of the optical axis of the first optical element 170 from the first emitted light L1 less affects the performance of the apparatus. In other words, greater deviation of the optical axis of the first optical element 170 from the first emitted light L1 can be tolerated in an optical axis adjustment process.

The first optical element 170 is an optical element obtained by integrating the first lens surface 172, the first reflection surface 174, and the second lens surface 176. The first optical element 170 can be made of BK7 or any other suitable optical glass. For example, the first reflection surface 174 can be the surface of a metal film (not shown) deposited on part of a member made of optical glass. The optical axis of the first lens surface 172 is, for example, parallel to the third surface 146 of the base 140. The optical axis of the second lens surface 176 is, for example, parallel to a normal to the third surface 146 of the base 140. The optical axis of the first lens surface 172 intersects the optical axis of the second lens surface 176 at right angles at the first reflection surface 174.

The second optical element 180 is supported by the base 140. More specifically, the second optical element 180 is supported by the second surface 144 and the third surface 146 of the base 140. The second optical element 180 can convert the second emitted light L2 emitted from the light emitting device 100 into collimated light and change the traveling direction of the second emitted light L2. The second optical element 180 has a third lens surface 182, the second reflection surface 184, and a fourth lens surface 186. The third lens surface 182 is a surface on which the second emitted light L2 is incident. The third lens surface 182 can convert the second emitted light L2 into collimated light. The second emitted light L2 can be refracted at the third lens surface 182 and converted into collimated light. The third lens surface 182 can be, for example, a convex surface. The third lens surface 182 may alternatively be an aspheric surface, which can reduce the amount of aberration. The second reflection surface 184 can reflect the light having passed through the third lens surface 182 upward above the light emitting device 100, as shown in FIG. 2. The second emitted light L2 is reflected off the second reflection surface 184 and can travel, for example, vertically upward (direction Z in FIG. 1) with respect to the third surface 146 of the base 140. The reflected light is referred to as second reflected light L4. The second reflection surface 184 is inclined, for example, to the third surface 146 by 45 degrees. As a result, the traveling direction of the second reflected light L4 can be perpendicular to the traveling direction of the second emitted light L2. The reflectance at which the second reflection surface 184 reflects the second emitted light L2 is preferably higher than 50% but lower than or equal to 100%. The fourth lens surface 186 can convert the second reflected light L4 into collimated light. The second reflected light L4 can be refracted at the fourth lens surface 186 and converted into collimated light. The fourth lens surface 186 can be the surface of the second optical element 180 through which light exits. The fourth lens surface 186 can be, for example, a convex surface. The fourth lens surface 186 may alternatively be an aspheric surface, which can reduce the amount of aberration. The second optical element 180 can use the third lens surface 182 and the fourth lens surface 186 to convert the second emitted light L2 into collimated light. Therefore, the parallelism of the light having exited through the fourth lens surface 186 can be higher (the degree of divergence of the light can be smaller) than that obtained in a case where only one lens surface converts the second emitted light L2 into collimated light. Further, according to the configuration described above, deviation of the optical axis of the second optical element 180 from the second emitted light L2 less affects the performance of the apparatus. In other words, greater deviation of the optical axis of the second optical element 180 from the second emitted light L2 can be tolerated in an optical axis adjustment process.

The second optical element 180 is an optical element obtained by integrating the third lens surface 182, the second reflection surface 184, and the fourth lens surface 186. The second optical element 180 can be made of BK7 or any other suitable optical glass. For example, the second reflection surface 184 can be the surface of a metal film (not shown) deposited on part of a member made of optical glass. The optical axis of the third lens surface 182 is, for example, parallel to the third surface 146 of the base 140. The optical axis of the fourth lens surface 186 is, for example, parallel to a normal to the third surface 146 of the base 140. The optical axis of the third lens surface 182 intersects the optical axis of the fourth lens surface 186 at right angles at the second reflection surface 184.

The traveling direction of the first emitted light L1 is perpendicular to the line V along which a plane parallel to the third surface 146 of the base 140 (X-Y plane) intersects the first reflection surface 174 at right angles, as shown in FIG. 1. Similarly, the traveling direction of the second emitted light L2 is perpendicular to a line W along which a plane parallel to the third surface 146 of the base 140 intersects the second reflection surface 184 at right angles.

The lid 190 is disposed on the base 140, as shown in FIG. 2. The lid 190 can seal the recess 148 in the base 140 so that the light emitting device 100 provided in the recess 148 can be encapsulated. The lid 190 is made of a material that is transparent to the wavelength of the reflected light L3 and L4. Therefore, at least part of the first reflected light L3 can pass through the lid 190, and at least part of the second reflected light L4 can pass through the lid 190. The lid 190 can be made, for example, of quartz, glass, crystal, or plastic. One of the above materials can be selected as appropriate in accordance with the wavelength of the reflected light L3 and L4. Optical absorption loss can thus be reduced.

The light emitting apparatus 1000 has been described with reference to the case where the light emitting device 100 is made of an InGaAlP-based material by way of example, but the light emitting device 100 can alternatively be made of any material that can forma region where emitted light is amplified. Exemplary useable semiconductor materials may include AlGaN-based, InGaN-based, GaAs-based, InGaAs-based, GaInNAs-based, and ZnCdSe-based semiconductor materials.

The light emitting apparatus 1000 has, for example, the following features.

According to the light emitting apparatus 1000, the optical elements 170 and 180 can use their lens surfaces (first lens surface 172 and third lens surface 182) to convert the light beams L1 and L2 emitted from the light emitting device 100 into collimated light before the light beams L1 and L2 are reflected off the reflection surfaces 174 and 184. As compared with, for example, a case where light emitted from a light emitting device is reflected off a reflection surface and then incident on a lens surface, the light emitting apparatus 1000 allows the emitted light to be incident on the lens surface without using any reflection surface, whereby the lens surface can be closer to the light emitting device. That is, since the light beams L1 and L2 emitted from the light emitting device 100 travel shorter distances along their optical paths before they are incident on the respective lenses (first lens surface 172 and third lens surface 182), the emitted light beams L1 and L2 incident on the respective lens surfaces (first lens surface 172 and third lens surface 182) can be small in diameter. The aperture diameters of the lens surfaces (first lens surface 172 and third lens surface 182) can therefore be reduced. As a result, the optical elements 170 and 180 and hence the light emitting apparatus can be small in size.

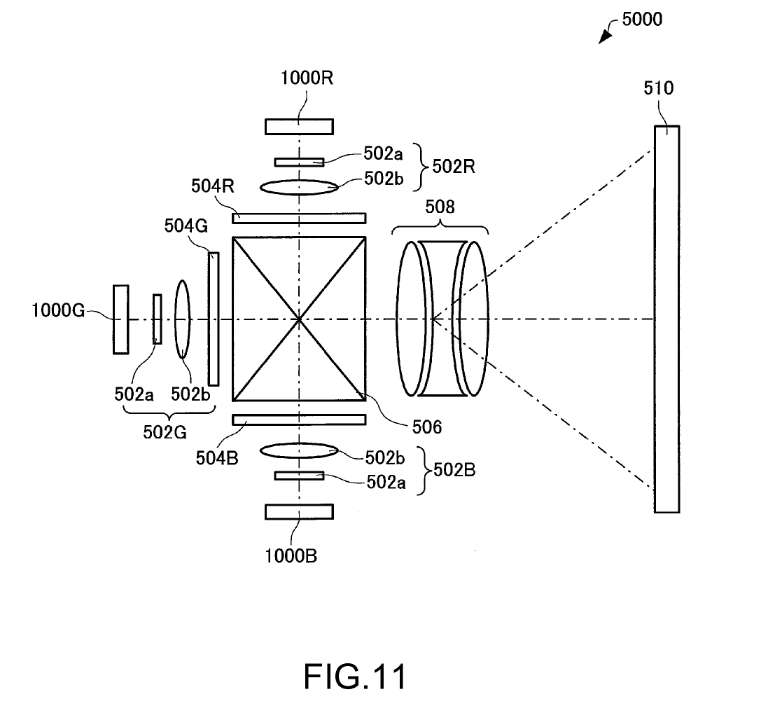

Further, in general, an SLD, a semiconductor laser, or any other light emitting device emits light having a large angle of radiation. As a result, for example, if the vertical angle of radiation of the light emitted from the light emitting device (one-half the apex angle of the cone light emitted through the exiting surface) is larger than the angle of a reflection surface with respect to the traveling direction of the emitted light, part of the emitted light is not reflected off the reflection surface but is lost. According to the light emitting apparatus 1000, however, the emitted light L1 and L2 is converted into collimated light through the respective lens surfaces (first lens surface 172 and third lens surface 182) and then incident on the reflection surfaces 174 and 184, whereby optical loss can be reduced irrespective of the angle of radiation of the emitted light L1 and L2. The emitted light L1 and L2 can therefore be guided to a downstream optical system (homogenizing systems 502R, 502G, and 502B shown in FIG. 11, for example) at a low optical loss.

According to the light emitting apparatus 1000, the two emitted light beams L1 and L2 can be reflected in the same direction. That is, the traveling direction of the light having exited through the second lens surface 176 of the first optical element 170 (the traveling direction of the first reflected light L3 reflected off the first reflection surface 174) can be the same as the traveling direction of the light having exited through the fourth lens surface 186 of the second optical element 180 (the traveling direction of the second reflected light L4 reflected off the second reflection surface 184). As a result, when the light emitting apparatus is used, for example, as alight source of a projector, the configuration of the optical system of the projector can be simplified, and the optical axis can be readily aligned in the projector.

According to the light emitting apparatus 1000, the base 140 can have the first surface 142, which supports the first reflection surface 174 of the first optical element 170, and the second surface 144, which supports the second reflection surface 184 of the second optical element 180. The configuration of the base 140 allows the optical axes of the optical elements 170 and 180 to be readily adjusted with respect to the light emitting device 100. That is, according to the present embodiment, the first surface 142 can position the first optical element 170 with respect to the light emitting device 100 in the traveling direction of the first emitted light L1, and the second surface 144 can position the second optical element 180 with respect to the light emitting device 100 in the traveling direction of the second emitted light L2. The optical axes of the optical elements 170 and 180 can therefore be readily adjusted with respect to the light emitting device 100.

According to the light emitting apparatus 1000, the first optical element 170 can be an optical element obtained by integrating the first lens surface 172, the first reflection surface 174, and the second lens surface 176. Similarly, the second optical element 180 can be an optical element obtained by integrating the third lens surface 182, the second reflection surface 184, and the fourth lens surface 186. The optical system can therefore be reduced in size.

According to the light emitting apparatus 1000, the light emitting device 100 can be an SLD. It is therefore possible to suppress or prevent laser oscillation of the light produced in the gain region 160. As a result, the amount of speckle noise can be reduced.

### 2. Method for Manufacturing Light Emitting Apparatus

A method for manufacturing the light emitting apparatus 1000 according to the present embodiment will next be described with reference to the drawings. FIGS. 4 to 7 are cross-sectional views diagrammatically showing the steps of manufacturing the light emitting apparatus 1000.

As shown in FIG. 4, the second cladding layer 104, the active layer 106, the first cladding layer 108, and the contact layer 110 are formed in this order on the substrate 102 in an epitaxial growth process. Exemplary methods for performing the epitaxial growth may include MOCVD (Metal Organic Chemical Vapor Deposition) and MBE (Molecular Beam Epitaxy).

As shown in FIG. 5, the insulator 116 having an opening is formed on the contact layer 110. The insulator 116 is formed, for example, by using CVD (Chemical Vapor Deposition). The opening can be formed, for example, by patterning the insulator in photolithography and etching processes in such a way that part of the contact layer 110 is exposed.

The first electrode 114 is then formed on the exposed contact layer 110 and the insulator 116. The second electrode 112 is then formed on the lower surface of the substrate 102. The first electrode 114 and the second electrode 112 are formed, for example, by using vacuum deposition. The order in which the first electrode 114 and the second electrode 112 are formed is not limited to a specific one. The light emitting device 100 can be manufactured by carrying out the steps described above.

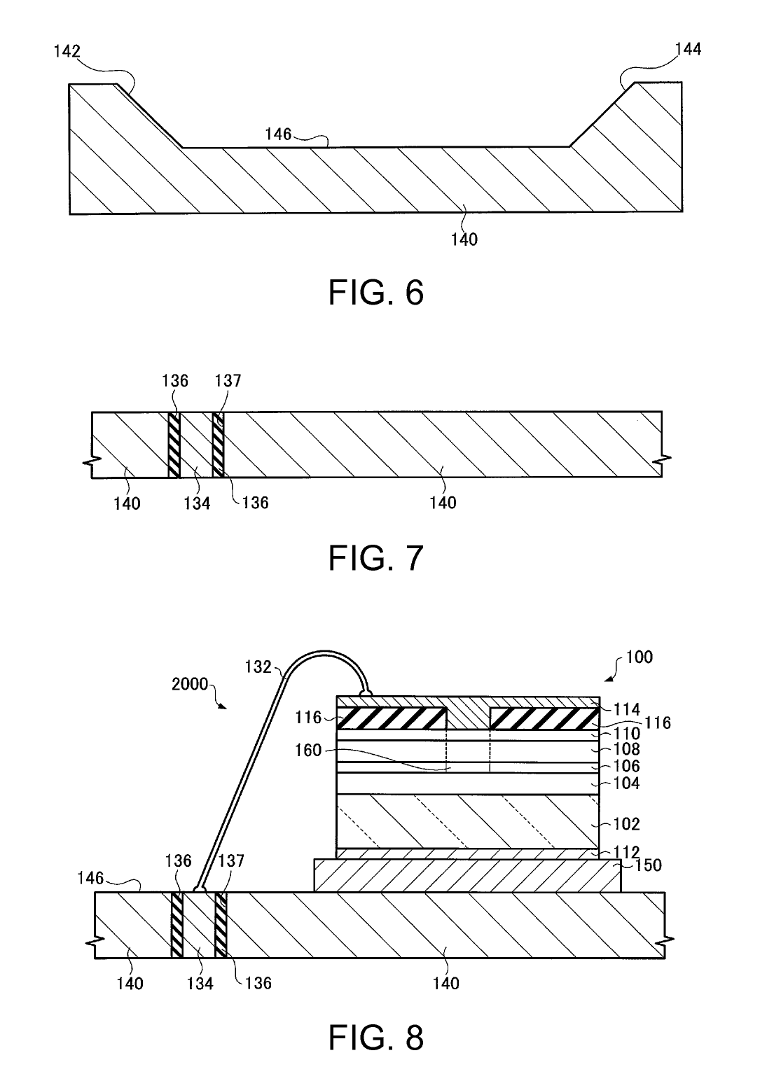

As shown in FIG. 6, the base 140 having the first surface 142, the second surface 144, and the third surface 146 is manufactured, for example, in a cutting process.

As shown in FIG. 7, the through hole 137 is formed through the base 140 by using a known method. The insulating member 136 is formed in such a way that it covers the inner side surface of the through hole 137 but does not entirely block the through hole 137. The insulating member 136 is deposited, for example, by using CVD. The rod-shaped terminal 134 is then inserted into the insulating member 136. Alternatively, the insulating member 136 may be formed around the rod-shaped terminal 134, and the terminal 134 with the insulating member 136 therearound may then be inserted into the through hole 137.

The first optical element 170 and the second optical element 180 are then manufactured. The optical elements 170 and 180 can be manufactured, for example, by using injection molding or a 2P method. Manufacturing the optical elements 170 and 180 by a die in an injection molding or 2P process allows the optical axes of the first lens surface 172 and the second lens surface 176 of the first optical element 170 to be aligned with each other with precision and the optical axes of the third lens surface 182 and the fourth lens surface 186 of the second optical element 180 to be aligned with each other with precision.

As shown in FIG. 3, the light emitting device 100 is first mounted on the sub-mount 150, and the sub-mount 150 on which the light emitting device 100 has been mounted is then mounted on the base 140. The light emitting device 100 is mounted in such a way that the active layer 106 is located on the side close to the base 140 (junction-down mounting). That is, the light emitting device 100 can be mounted in a flip-chip manner.

The terminal 134 is then connected to the second electrode 112 of the light emitting device 100 via the connecting member 132. The present step is carried out, for example, in a wire bonding process.

The first optical element 170 is disposed in such a way that it is supported by the first surface 142 and the third surface 146 of the base 140, as shown in FIGS. 1 and 2. Similarly, the second optical element 180 is disposed in such a way that it is supported by the second surface 144 and the third surface 146 of the base 140. In the process in which the optical elements 170 and 180 are disposed, the optical axes thereof are also adjusted with respect to the emitted light L1 and L2. The optical elements 170 and 180 may be fixed to the base 140, for example, with an adhesive.

As shown in FIG. 2, the lid 190 is bonded or welded to the base 140, for example, in a nitrogen atmosphere. The light emitting device 100 can thus be sealed.

The light emitting apparatus 1000 can be manufactured by carrying out the steps described above.

### 3. Variations of Light Emitting Apparatus

Light emitting apparatus according to variations of the present embodiment will next be described with reference to the drawings. In the following light emitting apparatus according to the variations of the present embodiment, members having the same functions as those of the components of the light emitting apparatus 1000 according to the present embodiment have the same reference characters, and no detailed description of those members will be made.

### 3-1 Light Emitting Apparatus According to First Variation

A description will first be made of a light emitting apparatus 2000 according to a first variation of the present embodiment. FIG. 8 is a cross-sectional view diagrammatically showing the light emitting apparatus 2000. FIG. 8 corresponds to FIG. 3. In FIG. 8, the lid 190 is omitted for ease of illustration.

In the light emitting apparatus 1000, the active layer 106 is disposed on the side close to the base 140 in the light emitting device 100, as shown in FIG. 3. On the other hand, in the light emitting apparatus 2000, the active layer 106 is disposed on the side away from the base 140 in the light emitting device 100, as shown in FIG. 8. That is, the active layer 106 is disposed above the intermediate level in the thickness direction in the light emitting device 100. In the light emitting apparatus 2000, the substrate 102 is disposed between the active layer 106 and the base 140. The second electrode 112 is connected to the sub-mount 150, for example, via a connecting member (not shown). The first electrode 114 is connected to the terminal 134, for example, via the connecting member 132.

According to the light emitting apparatus 2000, since the substrate 102 is disposed between the active layer 106 and the base 140, the active layer 106 is further spaced apart from the base 140 by at least a distance corresponding to the substrate 102, as compared with the light emitting apparatus 1000. As a result, (the cross section of) the emitted light can be shaped in a more satisfactory manner. For example, when the light exits from the gain region 160 at a large angle of radiation, part of the exiting light is blocked by the base 140, and the shape of the exiting light is distorted in some cases. The light emitting apparatus 2000 does not suffer from such a problem.

### 3-2 Light Emitting Apparatus According to Second Variation

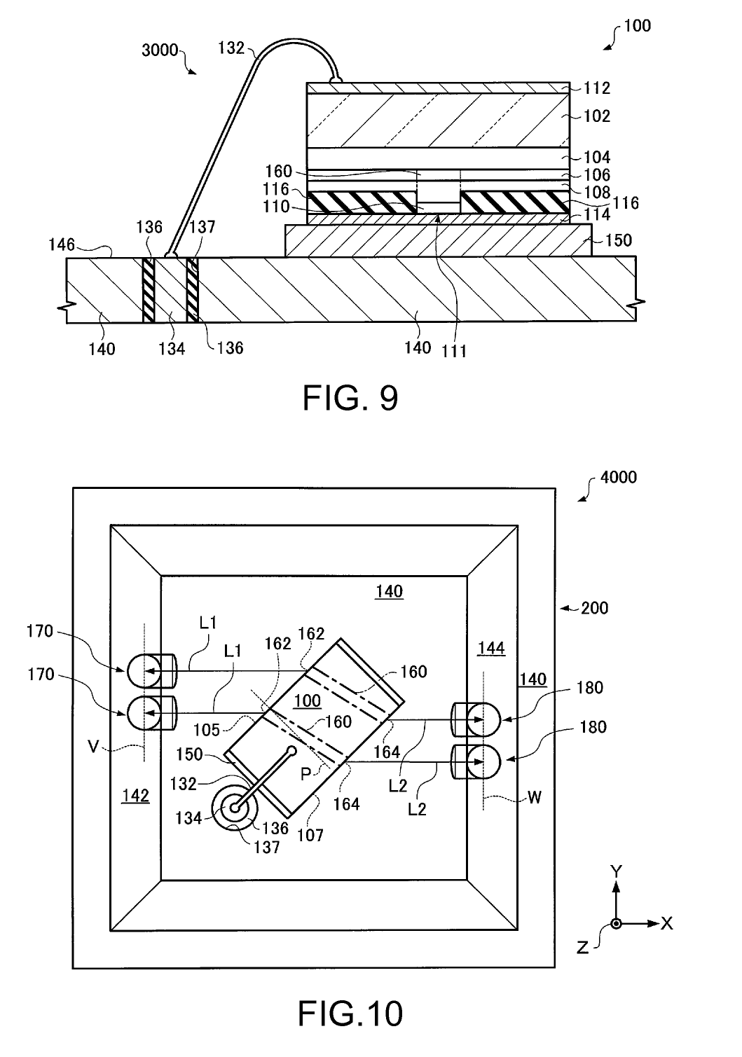

A description will next be made of a light emitting apparatus 3000 according to a second variation of the present embodiment with reference to the drawings. FIG. 9 is a cross-sectional view diagrammatically showing the light emitting apparatus 3000. FIG. 9 corresponds to FIG. 3. In FIG. 9, the lid 190 is omitted for ease of illustration.

The light emitting apparatus 1000 has been described with reference to what is called a gain-guided version. On the other hand, the light emitting apparatus 3000 can be what is called a refractive-index-guided version.

That is, in the light emitting apparatus 3000, the contact layer 110 and part of the first cladding layer 108 can form a column-shaped portion 111, as shown in FIG. 9. The column-shaped portion 111 and the gain region 160 have the same shape in a plan view. For example, the shape of the column-shaped portion 111 in a plan view determines a current path between the electrodes 112 and 114 and hence the shape of the gain region 160 in a plan view. Although not illustrated, the column-shaped portion 111 may alternatively be formed, for example, of the contact layer 110 and part of the first cladding layer 108 and the active layer 106, or may further include part of the second cladding layer 104. Further, the side surfaces of the column-shaped portion 111 may be inclined.

The insulator 116 is formed on both sides of the column-shaped portion 111. The insulator 116 can be in contact with the side surfaces of the column-shaped portion 111. The current between the electrodes 112 and 114 can flow through the column-shaped portion 111 in the insulator 116 but not therethrough. The refractive index of the insulators 116 can be smaller than that of the active layer 106. As a result, light can be efficiently trapped in the gain region 160 in the horizontal direction (the direction parallel to the upper surface of the active layer 106).

### 3-3 Light Emitting Apparatus According to Third Variation

A description will next be made of a light emitting apparatus 4000 according to a third variation of the present embodiment with reference to the drawings. FIG. 10 is a plan view diagrammatically showing the light emitting apparatus 4000. FIG. 10 corresponds to FIG. 1. In FIG. 10, the lid 190 is omitted for ease of illustration.

In the light emitting device 100 in the light emitting apparatus 1000, one gain region 160 is provided in the active layer 106, as shown in FIGS. 1 and 3. On the other hand, in the light emitting apparatus 4000, a plurality of gain regions 160 can be provided in the active layer 106, as shown in FIG. 10. That is, the light emitting device 100 can have a plurality of first exiting surfaces (first end surfaces) 162 and a plurality of second exiting surfaces (second end surfaces) 164. Two gain regions 160 are provided in the illustrated example, but the number of gain regions 160 is not limited to a specific value.

According to the light emitting apparatus 4000, the output from the entire light emitting apparatus can be higher than that from the light emitting apparatus 1000.

According to the light emitting apparatus 4000, since each of the first optical element 170 and the second optical element 180 has a small size, a plurality of gain regions 160 can be arranged at a high density.

### 4. Projector

A projector 5000 according to the present embodiment will next be described with reference to the drawings. FIG. 11 diagrammatically shows the projector 5000. In FIG. 11, a housing that is part of the projector 5000 is omitted for ease of illustration.

In the projector 5000, a red light source (light emitting apparatus) 1000R that emits red light, a green light source (light emitting apparatus) 1000G that emits green light, and a blue light source (light emitting apparatus) 1000B that emits blue light are the light emitting apparatus according to the invention (light emitting apparatus 1000, for example).

The projector 5000 includes transmissive liquid crystal light valves (light modulating apparatus) 504R, 504G, and 504B that modulate the light beams emitted from the light sources 1000R, 1000G, and 1000B in accordance with image information and a projection lens (projection apparatus) 508 that enlarges images formed by the liquid crystal light valves 504R, 504G, and 504B and projects the enlarged images on a screen (display surface) 510. The projector 5000 can further include a cross dichroic prism (light combining unit) 506 that combines the light beams having exited from the liquid crystal light valves 504R, 504G, and 504B and guides the combined light to the projection lens 508.

The projector 5000 further includes homogenizing systems 502R, 502G, and 502B provided in the respective optical paths downstream of the light sources 1000R, 1000G, and 1000B. The homogenizing systems 502R, 502G, and 502B homogenize the illuminance distributions of the light beams emitted from the light sources 1000R, 1000G, and 1000B. The light beams having the thus homogenized illuminance distributions illuminate the liquid crystal light valves 504R, 504G, and 504B. Each of the homogenizing systems 502R, 502G, and 502B is formed, for example, of a hologram 502a and a field lens 502b.

The three color light beams having been modulated by the respective liquid crystal light valves 504R, 504G, and 504B are incident on the cross dichroic prism 506. The prism is formed by bonding four rectangular prisms and thus has internal surfaces that intersect each other. One of the internal surfaces has a dielectric multilayer film that reflects red light, and the other internal surface has a dielectric multilayer film that reflects blue light. The dielectric multilayer films combine the three color light beams and form light representing a color image. The combined light is then projected through the projection lens 508, which is a projection system, on the screen 510 and displays a single enlarged image.

According to the projector 5000, the light emitting apparatus 1000 having a small size can be used as alight source, as described above. The size of the projector 5000 can therefore be reduced.

In the example described above, a transmissive liquid crystal light valve is used as the light modulating apparatus. Alternatively, a light valve that is not based on the liquid crystal technique or a reflective light valve may be used. Examples of the alternative light valve may include a reflective liquid crystal light valve and a digital micromirror device. The configuration of an optical system is changed as appropriate in accordance with the type of the light valve to be used.

The light emitting apparatus 1000 can also be used as a light source apparatus of a scanning image display apparatus (projector) including a scan unit that is an image formation apparatus that displays an image on a display surface at a desired magnification by scanning a screen with the light from the light emitting apparatus 1000.

The embodiment and the variations described above have been presented by way of example, and the present invention is not limited thereto. For example, any of the embodiment and the variations can be combined as appropriate.

Embodiments of the invention have been described in detail. The skilled in the art will readily understand that many other variations that do not substantially depart from the novel features and advantageous effects of the invention can be implemented. It is therefore intended that all such variations fall within the scope of the invention.

The entire disclosure of Japanese Patent Application No. 2009-264774, filed Nov. 20, 2009 is expressly incorporated by reference herein.

What is claimed is:

1. A light emitting apparatus comprising:
a base;
a light emitting device supported by the base, the light emitting device emitting first emitted light and second emitted light traveling in opposite directions;
a first optical element on which the first emitted light is incident; and
a second optical element on which the second emitted light is incident,
wherein the first optical element includes
a first lens surface on which the first emitted light is incident and which converts the first emitted light into collimated light,
a first reflection surface that reflects the light having passed through the first lens surface, and
a second lens surface that converts the light reflected off the first reflection surface into collimated light,
the second optical element includes
a third lens surface on which the second emitted light is incident and which converts the second emitted light into collimated light,
a second reflection surface that reflects the light having passed through the third lens surface, and
a fourth lens surface that converts the light reflected off the second reflection surface into collimated light, and
the light having exited through the second lens surface of the first optical element and the light having exited through the fourth lens surface of the second optical element travel in the same direction.

2. The light emitting apparatus according to claim 1,
wherein the base has a first surface that supports the first reflection surface of the first optical element and a second surface that supports the second reflection surface of the second optical element.

3. The light emitting apparatus according to claim 1,
wherein the base has a third surface that supports the light emitting device,
the light emitting device is disposed in such a way that the traveling direction of the first emitted light and the traveling direction of the second emitted light are parallel to the third surface, and
the first and second reflection surfaces are inclined to the third surface by 45 degrees.

4. The light emitting apparatus according to claim 1,
wherein the light emitting device is a super luminescent diode.

5. The light emitting apparatus according to claim 1,
wherein the light emitting device has a plurality of first exiting surfaces through each of which the first emitted light exits and a plurality of second exiting surfaces through each of which the second emitted light exits.

6. A projector comprising:
the light emitting apparatus according to claim 1;
a light modulating apparatus that modulates the light having exited from the light emitting apparatus in accordance with image information; and
a projection apparatus that projects an image formed by the light modulating apparatus.
